(19) United States
(12) Patent Application Publication
(10) Pub. No.: US 2005/0165822 A1
(43) Pub. Date: Jul. 28, 2005

(54) Systems and methods for business process automation, analysis, and optimization

(75) Inventors: Simon D. Yeung, Fremont, CA (US); Kenneth B. Goldstein, Mountain View, CA (US); Gary R. Horne, Milpitas, CA (US)

Correspondence Address: LOGIC SIGHT, INC., 487 Heath Street, Milpitas, CA, 95035, US

(73) Assignee: LOGIC SIGHT, INC.

(21) Appl. No.: 10/762,918

(22) Filed: Jan. 22, 2004

(51) Int. Cl. G06F 17/00

(52) U.S. Cl. 707/102

(57) ABSTRACT

A method of carrying out a business process includes obtaining an entity model representative of an entity to which a task associated with said business process can be assigned, obtaining a work model representative of a task to be assigned to said entity, and assigning said task to said entity based on said entity model and said work model to thereby carry out said business process. A method for optimizing a business process includes collecting a first set of data associated with an execution of a first business process model representative of a first business process, searching a data base for a second business process model representative of a second business process, and comparing said first set of data with a second set of data associated with said second business process.

### BACKGROUND OF THE INVENTION

1. Field of the Invention

The field of the invention relates to software and computer products, and more particularly, to software and computer products for business process automation, analysis, and optimization.

2. Background of the Invention

Business processes at different levels are carried out every day. However, many business entities do not document business functions as re-usable business processes. As a result, execution of a business process is usually an ad-hoc interpretation by those who are part of the process. Particularly, because an individual involved in a business process may not be aware of the same or similar processes that were previously executed, and because previously executed processes may be so poorly managed or documented that it requires more work to organize and reuse previous materials than to start a process from scratch, many business process are often re-invented and re-documented over again even though the same or similar process was previously executed. For examples, data associated with execution of a business process, such as sequences of steps, and establishment of appropriate contacts, are usually not documented. As a result, these types of data usually needs to be re-established in the same or similar business process, which leads to unnecessary waste of time and resources. Also, essential information that could lead to improvement in a business process is often inaccessible or lost because such information may not be well documented. The results are inefficiencies and loss in productivity.

Another problem associated with business process execution is that a lot of time and resources are needed in order to train newly hired individual(s) to become familiar with the environment, people, existing processes, and chains of communication associated with a business process. This is due to the fact that newly hired individual(s) does not know or is not familiar with entities that are involved in a project, the overall picture of the project, where the individual(s) fit into the process, and the specific segment of work for which the individual(s) is responsible. In addition, requests for information and assignments of work are often times submitted to the wrong candidates, and work specifications and results can be mis-communicated. As such, there is a need for a system that can adequately manage work requests in all stages of a business process. Such system should also be capable of providing individuals visibility to job functions so that newly hired individuals can become familiar with the specific segment of work for which the individual(s) is responsible without spending unnecessary time and resources.

Business entities also do not have the resources nor the technologies to adequately monitor a business process that is being executed. Particularly, because it is not easy to break down a business process into sizable, traceable, and measurable segments of works that can be monitored, many business processes are not capable of being monitored when the processes are being executed. Currently, there is a need for a system that is capable of tracking and measuring progresses of all stages of a business process, thereby providing optimal control over the whole process. In addition, business process execution results are generally vaguely quantified or not measurable at all. As the results, execution of a business process cannot be benchmarked, and results of recurrent business process execution and different business process cannot be compared. Therefore, there is also a need for a system that can adequately analyze a performance of a business process.

Furthermore, many business entities do not have the technologies that allow them to adequately track and analyze business process results. This makes optimization of a business process and accountability for success difficult. Currently, there is a need for a system that can assist a business entity in detecting bottleneck and source of failure for a business process, such that a same mistake will not be repeated if the same or similar business process is to be carried out in the future. Such system should also be able to document value-adding methods, innovations, and discoveries during an execution of a business process.

Accordingly, system and method for business process automation, analysis, and optimization are desirable.

### SUMMARY OF THE INVENTION

In accordance with some embodiments of the invention, a method of carrying out a business process includes obtaining an entity model representative of an entity to which a task associated with said business process can be assigned, obtaining a work model representative of a task to be assigned to the entity, and assigning the task to the entity based on the entity model and the work model to thereby carry out the business process. In some embodiments, the method further includes creating a business process model using the entity model and the work model. By means of non-limiting examples, the entity can be a person, a group of persons, a machine, a device, a software, a company, an association, or a country.

In accordance with other embodiments of the invention, a method for optimizing a business process includes collecting a first set of data associated with an execution of a first business process model representative of a first business process, searching a data base for a second business process model representative of a second business process, and comparing the first set of data with a second set of data associated with the second business process. In some embodiments, the searching is performed using identifications of business process models. In alternative embodiments, the searching is performed by comparing work steps in the first business process model with work steps in previously created or executed business process models.

In accordance with other embodiments of the invention, a method for optimizing a business process involving a performance of a task is provided. The method includes obtaining data associated with performance of the task, comparing the data with data associated with previously created business process, and automatically determining an optimized business process based at least on the comparing. By means of non-limiting examples, the automatically determining can be performed using a software, a hardware, or combination of both.

In accordance with other embodiments of the invention, a computer product having a set of stored instructions is provided. An execution of the instructions causes a process to be performed, wherein the process includes providing an entity template representative of an entity to which a task associated with a business process can be assigned. In some embodiments, the process further includes providing a work template representative of a task which can be assigned to the entity. In other embodiments, the process also includes assigning the task to the entity. By means of non-limiting examples, the entity can be a person, a group of persons, a machine, a device, a software, a company, an association, or a country.

In accordance with other embodiments of the invention, a computer product having a set of stored instructions is provided. An execution of the instructions causes a process to be performed, wherein the process includes providing a user interface for allowing a user to create an entity model representative of an entity to which a task associated with a business process can be assigned. In some embodiments, the process further includes providing a user interface for allowing a user to create a work model representative of a task that can be assigned to the entity. In other embodiments, the process also includes assigning the task to the entity. By means of non-limiting examples, the entity can be a person, a group of persons, a machine, a device, a software, a company, an association, or a country.

In accordance with other embodiments of the invention, a computer product having a set of stored instructions is provided. An execution of the instructions causes a process to be performed, wherein the process includes collecting a first set of data associated with an execution of a first business process model representative of a first business process, searching a data base for a second business process model representative of a second business process, and comparing the first set of data with a second set of data associated with the second business process. In some embodiments, the first business process model includes a first plurality of work steps, and the searching comprises finding a business process model that has same or similar work steps as those associated with the first business process model. In other embodiments, the first business process model has a first model identification, and the searching comprises finding a business process model that has a same or a similar model identification as that of the first business process model.

In accordance with other embodiments of the invention, a system for business process automation and optimization includes a business process creation module for allowing a user to create a business model, the business process model having one or more work steps, and a business process execution and monitoring module configured to assign one or more tasks to one or more entities based on the business process model. In some embodiments, the system further includes a business process analysis and optimization module for optimizing a business process based on data collected from execution of the one or more tasks.

Other aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting its scope, the invention will be described and explained with additional specificity and detail through the use of the accompanying drawings.

FIG. 1 is a block diagram illustrating components of a system for performing business process automation, analysis, and optimization in accordance with some embodiments of the invention;

FIG. 2 is a flowchart illustrating a method of business process automation, analysis, and optimization in accordance with some embodiments of the invention;

FIG. 3A-3C illustrates examples of entity models in accordance with some embodiments of the invention;

FIG. 4 illustrates an example of a business process model in accordance with some embodiments of the invention;

FIG. 5 is a flowchart illustrating a method of performing business process simulation in accordance with some embodiments of the invention;

FIG. 6 is a flowchart illustrating a method of performing business process execution and monitoring in accordance with some embodiments of the invention;

FIG. 7A is a flowchart illustrating a method of performing business process analysis and optimization in accordance with some embodiments of the invention;

FIG. 7B illustrates a data base for storing previously created business process models in accordance with some embodiments of the invention; and

FIG. 8 is a diagram of a computer hardware system with which embodiments of the present invention can be implemented.

### DETAILED DESCRIPTION OF THE ILLUSTRATED EMBODIMENTS

Various embodiments of the present invention are described hereinafter with reference to the figures. It should be noted that the figures are not drawn to scale and that elements of similar structures or functions are represented by like reference numerals throughout the figures. It should also be noted that the figures are only intended to facilitate the description of specific embodiments of the invention. They are not intended as an exhaustive description of the invention or as a limitation on the scope of the invention. In addition, an illustrated embodiment needs not have all the aspects or advantages of the invention shown. An aspect or an advantage described in conjunction with a particular embodiment of the present invention is not necessarily limited to that embodiment and can be practiced in any other embodiments of the present invention even if not so illustrated.

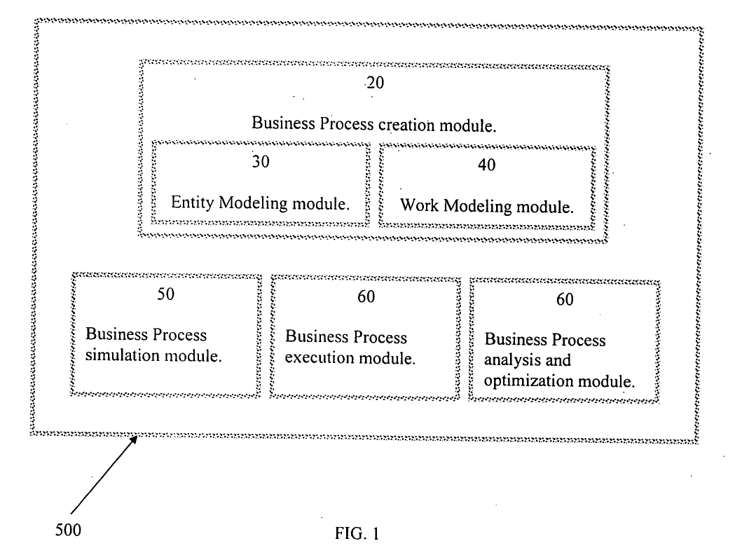

FIG. 1 is a block diagram illustrating an architecture of a system 10 for performing business process automation and optimization. The system 10 includes a business process creation module 20, a business process simulation module 50, a business process execution and monitoring module 60, and a business process analysis and optimization module 70. The business process creation module 20 provides a user interface for allowing a user (e.g., creator or initiator of a business process) to create a business process model representative of a task, an initiative, or a business process desired to be executed, and includes an entity modeling module 30 and a work modeling module 40. As used in this specification, the term, “business process” is not limited to processes that relate to business, or process that have economic or financial ramifications, and includes any processes that have defined goal(s) or objective(s). The entity modeling module 30 allows a user to create a model of an entity, such as a person, a group of persons, a machine, a software, a device, a company, an association, or a country, for performing a task or a process, and the work modeling module 40 allows a user to define a task or initiative assignable to an entity. Entity modeling and work modeling would be describe in further detail below. The business process simulation module 50 is configured to check the business process model for errors by performing a simulation run on the business process model. The business process execution and monitoring module 60 is configured to assign tasks and providing details of executing the tasks to one or more entities based on a created business process model. The business process execution and monitoring module 60 is also configured to collect results from tasks performed by each entity associated with a business process model. The business process analysis and optimization module 70 optimizes the business process by comparing the results (e.g., data collected by the business process execution and monitoring module 60) with previous results of the same or similar business process execution.

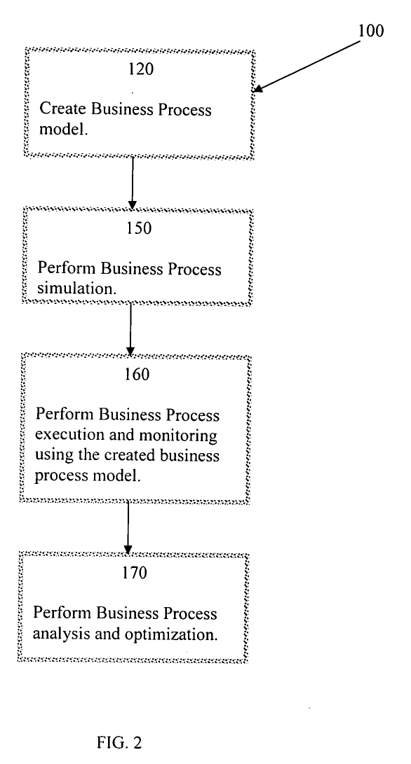

FIG. 2 is a flowchart illustrating a method 100 of business process automation, analysis, and optimization using the computer system 10 in accordance with some embodiments of the invention.

Business Process Modeling

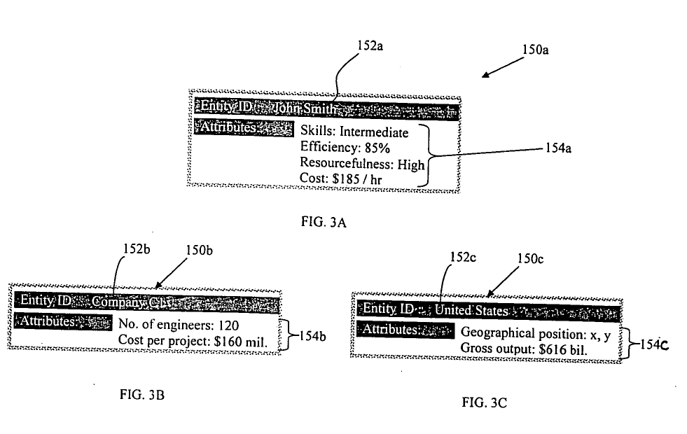

Initially, a user creates a business model by executing the business process creation module 20 (Step 120). As mentioned previously, the entity modeling module 30 of the business process creation module 20 allows the user to create a model of an entity capable of performing a task, and the work modeling model 40 allows the user to assign a task to an entity. FIG. 3A shows an example of an entity model 150a that can be created using the entity modeling module 30. The entity model 150a includes an entity identifier 152a, and one or more attributes 154a associated with the entity being modeled. In the illustrated example, the entity being modeled is a person by the name of “John Smith”. The entity model 150a includes the name “John Smith” as the entity identifier 152a, and the person's skills, work efficiency, resourcefulness, and cost as attributes 154a of the entity model 150a. Each attribute 154 has a corresponding attribute value. For example, the “Skills” attribute has an attribute value, “Intermediate”. In some embodiments, instead of using a real name as the entity model identification, the entity model can be identified by a customized identification number, code, or model name. It should be noted that the types of attributes 154 associated with an entity model 150 should not be limited to the examples discussed previously, and that an entity model 150 can have other attributes 154. In addition, an entity model 150 can also have an attribute value, “null”, or no attribute assigned to it.

As mentioned previously, an entity model can represents a company, a city, or other entities. FIG. 3B shows another example of an entity model 150b that represents a company having an identifier 152b, “Company C1”, and “Number of engineers” and “Cost per project” as its associating attributes 154b. FIG. 3C shows another example of an entity model 150c that represents a country having an identifier 152c, “U.S.”, and “Geographical position” and “Gross output” as its associating attributes 154c.

In some embodiments, the business process creation module 20 provides a number of entity templates representative of different entities (e.g., a person, a company, a city) that can be selected by a user when creating an entity model. Based on the entity template selected by the user, the business process creation module 20 then further provides a number of attributes that are associated with the selected type of entity to be selected by the user to complete the entity model 150. In other embodiments, the business process creation module 20 also allow a user to create a customized entity model having customized attribute(s). When the entity model 150 is completed, the file or record of the entity model 150 can be stored in a computer-readable medium or an electronic medium.

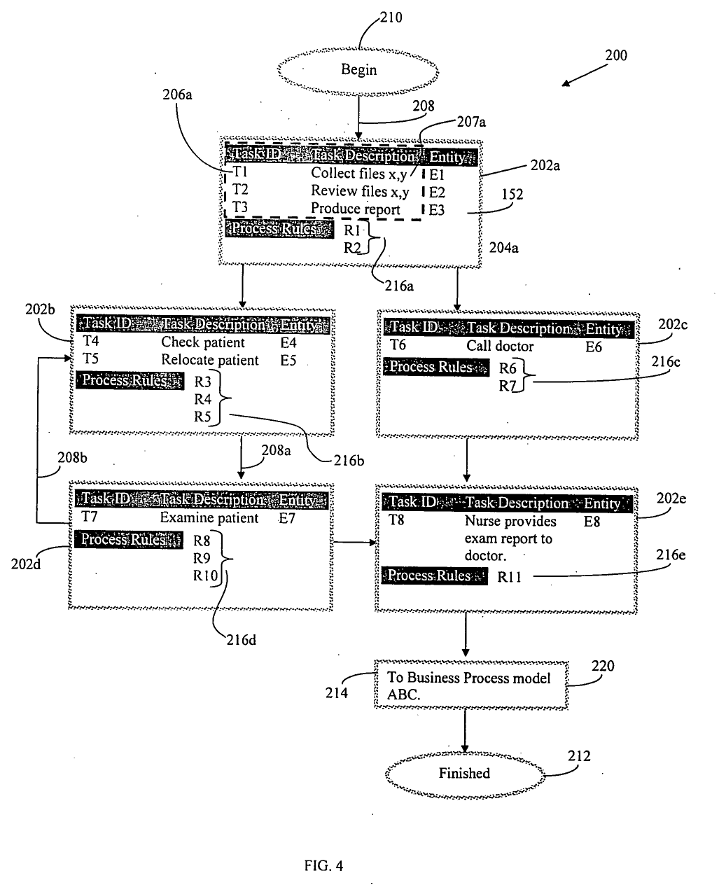

After an entity model 150 has been created, it can be used to create a business process model. FIG. 4 shows an example of a business process model 200 that can be created using the business process creation module 20. The business process model 200 is constructed in a flow chart formant, and includes a number of task blocks or work steps 202a-202e connected by work flow arrows 208. As shown in the illustrated example, a work step can lead to one or more other work steps, and one or more work steps can lead to a single work step. In addition, work steps can be connected through a loop, such as that represented by work flow arrows 208a and 208b. The business process model 200 can have work steps 202 connected in other configurations, and should not be limited to that shown in the example. In the illustrated example, the business model 200 further includes a process beginning identifier 210 for identifying a beginning of a business process, and a process ending identifier 212 representing an end of a business process. In some embodiments, the business process model 200 can be created without using the indicators 210, 212.

In the illustrated example, each work step 202 includes one or more tasks (or work models) 204, each of which having a task identification 206 and a respective task description 207. Each work step 202 also includes the identification 152 of entity or entities to be assigned for execution of the respective tasks. In the illustrated example, work step 202a includes tasks T1-T3 assigned to entities E1-E3, respectively. It should be noted that the same entity 150 in the work model 200 can perform more than one task. For example, in some embodiments, more than one tasks in a work step 202 can be assigned to the same entity, and different tasks from different work steps can also be assigned to the same entity. In addition, a single task can be performed by one or more entities.

Each work step 202 also includes one or more process rules 216. Each process rule 216 is an instruction defining one or more actions that will take place in response to pre-defined event(s) or non-events that occur during execution of the business process. For example, Rule R1 can be an instruction directing the system 10 to terminate the business process if files cannot be found by entity E1. A process rule can also direct the system 10 to modify the business process model 200, to notify an entity of certain events or information, and/or to request the user for input, in response to pre-defined events or non-events that occur during execution of the corresponding business process.

When creating the business process model 200, the tasks 204 can be typed or inputted by the user in text format or character-based format. Other types of format, such as PDF format, or other electronic formats known in the art can also be used. Details of execution can be provided when inputting the task description 207. For examples, a prescribed manner in carrying out the tasks, constraints, resources, what data is required from another entities, and timing of execution can be inputted by the user in the task description 207. Alternatively, the work modeling module 40 provides a list of available task templates from which the user can select to build the business process model 200. In such case, each task template can include details of execution, which can either be accepted by the user or be modified by the user for a particular business process model 200.

In some embodiments, one of the work steps 202 (e.g., work step 214) or one of the tasks 204 can include an identification 220 of a subsidiary business process model (i.e., a business process model within the business process model 200). In such cases, after work step 202e has been executed, the system 10 then executes the work steps associated with the subsidiary business process model prescribed in the work step 214. To complete the business model 200, the user also need to define work steps and tasks, and assign tasks to respective entities, in the subsidiary business process model 220. One or more of the work steps or tasks of the subsidiary business process model 220 can also include another subsidiary business process model.

In some embodiments, the work modeling module 40 allows a user to define one or more variables associated with each of the tasks in the work models 204, which allows the system 10 to track a progress and/or result of the tasks. For example, task T1 may have “time” and “cost” as its associating variables, and task T2 may have “number of completed unit” as its associating variable, and task T3 may have “number of reports produced” as its associating variable. Each task of the work step 202 can have other variables, and should not be limited to the examples discussed previously. In some embodiments, the work modeling module 40 provides a number of task types (e.g., perform research, design component X, sell goods) that can be selected by a user when creating a business process model. Based on the type of task selected by the user, the work modeling module 40 then further provides a number of variables that are associated with the selected type of task to be selected by the user to complete the business process model. In other embodiments, the work modeling module 40 also allow a user to create a customized task having customized variable(s).

In some embodiments, the user can assign a completion value to a variable of a task for identifying completion of the task. For example, the variable, “Number of completed unit”, of task 2, can be assigned a completion value of 100 units. In such case, when the actual number of completed unit reaches 100 units, then task 2 is considered completed. It should be noted that the completion value that can be assigned to a variable of a task can vary, depending on a parameter for measuring completion of a task. In other embodiments, instead of assigning a completion value to a variable of a task, the system 10 can determine a completion of a task based on feedback from the entity (or entities) assigned to the task. In some embodiments, the work modeling module 40 also allows a user to select one or more entities to which a progress or completion of the task 204 and/or the work step 202 is reported.

Business Process Simulation

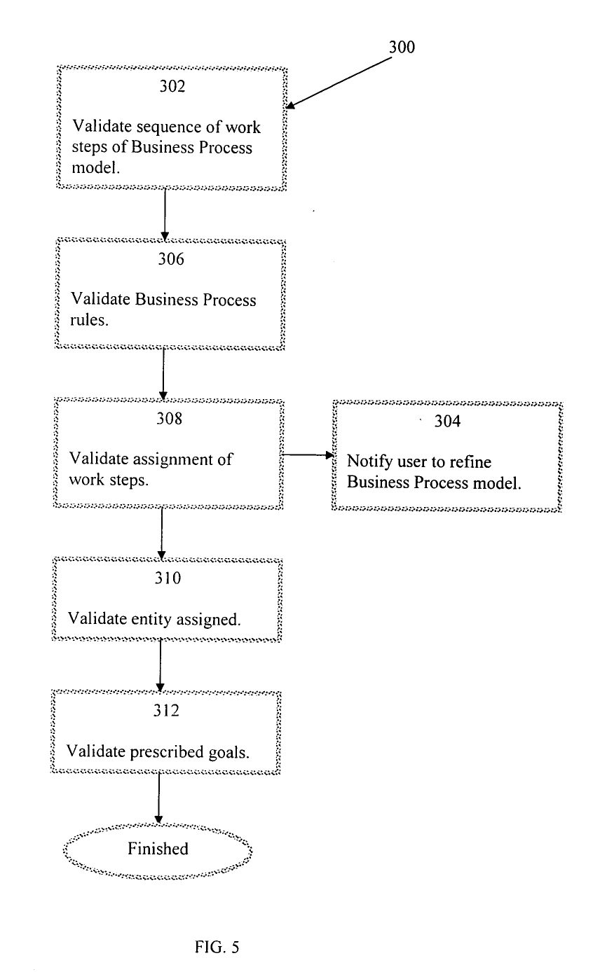

Returning to FIG. 2, after the business model 200 has been completed, the business model 200 is then checked for error by executing the business process simulation module 50 (Step 150). FIG. 5 illustrates a process 300 performed by the business process simulation module 50. First, the business process simulation module 50 validates a sequence of the work steps 202 in the business model 200 to make sure that there is no dead ends (e.g., perpetual loop, or work step not coupled to the business process ending identifier 212) or logical errors, and that all work steps 202 are defined (e.g., have defined task(s) 204) (Step 302). If a dead end or an inadequately defined work step 204 is identified, the business process simulation module 50 then signals the user to refine the business process model 200 (Step 304).

On the other hand, if no error is found, the business process simulation module 50 next validates business process rules (Step 306). Particularly, the business process simulation module 50 makes sure that the intended business process operates within process rules 216, that there are no contradicting process rules 216 within the business process model 200, and that the process rules 216 leads to desired end results. If an error is identified, the business process simulation module 50 then signals the user to refine the business process model 200 (Step 304).

Next, the business process simulation module 50 validates the entity or entities that have been assigned to the task(s) 204 of the business process model 200 (Step 308). Particularly, the business process simulation module 50 makes sure that each of the tasks 204 has been assigned to at least one entity, and that an entity assigned to perform a task 204 is valid. If a task 204 has not been assigned to at least one entity, or if an entity assigned for performing a task 204 cannot be identified, the business process simulation module 50 then signals the user to refine the business process model 200 (Step 304).

Next, the business process simulation module 50 also checks to make sure that entity assigned in a work step has the authority to carryout out the task 204 defined in the work step 202 (Step 310). For example, the assigned entity (e.g., an employee) may work for a different division within the company, may have a legal conflict with the work assigned to him, or may have a schedule conflict with other tasks that have been assigned to him. In such case, the business process simulation module 50 then signals the user to refine the business process model (Step 304).

Lastly, the business process simulation module 50 also validates business process goals (Step 312). Particularly, the business process simulation module 50 makes sure that each defined task 204 of the business process model 200 includes a measurable variable for reporting and/or a measurable variable for indicating completion of the task 204. the business process simulation module 50 also makes sure that an entity that has been assigned to receive report(s) or result(s) of a task 204 is valid. If an inadequately defined task 204 or an invalid entity for receiving report(s) has been identified, the business process simulation module 50 then signals the user to refine the business process model 200 (Step 304). On the other hand, if no error has been found, the business process simulation module 50 then generates a report of the simulation (or error checking) results for the user.

It should be noted that the checks (e.g., steps 302-312) described previously need not be performed in the sequence or order shown in the illustrated embodiments. For examples, in some embodiments, the checks can be performed in other sequences, and two or more checks can be performed simultaneously. Also, in some embodiments, the business process simulation module 50 can be configured to perform other checks, in addition to, or in substitution of, those described previously. In addition, not all of the checks described previously need to be performed by the business process simulation module 50. For example, in alternative embodiments, the business process simulation module 50 performs only one or some of the checks (Steps 302 and 306-312). Furthermore, in some embodiments, the system 10 does not include the business process simulation module 50, and the method 100 does not include the step of checking business model error.

Business Process Execution and Monitoring

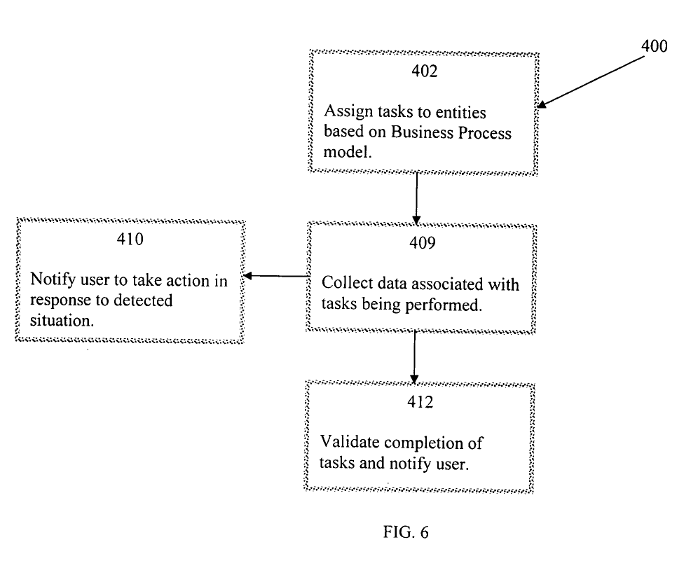

Returning to FIG. 2, after the business model 200 has been checked for error, the business process execution and monitoring module 60 executes the business process model 200 to initiate the business process (Step 160). FIG. 6 illustrates a process 400 performed by the business process execution and monitoring module 60. First, based on the business model 200 created, the business process execution and monitoring module 60 assigns tasks to respective entities (Step 402). Particularly, entities assigned to perform tasks are notified and details of execution of the tasks are provided to the respective entities. In the illustrated embodiments, the business process execution and monitoring module 60 notifies the entities via respective notification windows. In such cases, the business process execution and monitoring module 60 causes a window to be displayed in a computer screen, the window displaying information associated with task(s) that have been assigned to the entity. Alternatively, the business process execution and monitoring module 60 can also notify the entities by sending emails, telephonic messages, faxes, or other communication means know in the art of communication. For the cases in which the entities are applications, devices, or machines, the business process execution and monitoring module 60 transmits one or more command signals (or causes one or more command signals to be transmitted) to causes the entities to perform the prescribed tasks. Once the assigned entities receive the respective tasks 204 associated with the business process model 200, the entities then perform the assigned tasks 204 in accordance with the details of execution for the tasks 204.

While tasks are being performed by the assigned entities, data associated with the tasks are collected (Step 404). The type of data that can be collected vary, and depends on the particular task being carried out. For example, the data can be one or a combination of the variables associated with a particular task, and can include time of execution, cost of execution, resources spent, etc. In some embodiments, the user can define the data to be collected for each task 204 or work step 202 when creating the business process model 200. In alternative embodiments, the system 10 provides a list of the type of data associated with established tasks from which the user can select.

While the business process associated with the business process model 200 is being executed, the system 10 allows a user to check a progress of the business process. For example, the user can check to determine which of the work steps 202 of the business process model 200 is being executed, which entity's work is completed, which entity's work is being carried out, and a source of bottleneck. In addition, the system 10 also allows a user to compare current progress with set goals and targets. In some embodiments, the system 10 allows a user to create customized report(s) for monitoring different aspects of the business process being executed. In such cases, the system 10 can generate the report(s) using at least the data collected for each of the tasks 204.

In some cases, during execution of the business process, the business process execution and monitoring module 60 may detect a situation that requires a user's input. For examples, a resource usage for a task may exceed a prescribed level, an entity may become unavailable due to unforeseen circumstances, or an execution of a task may exceed a maximum allowable cost. In such cases, the system 10 can be configured to notify the user, and allow the user to take actions in response to the detected situation (Step 410). For example, the user can modify the business process model 200, override a particular business rule, or notify one or more entities to perform certain tasks. As such, the system 10 allows the user to participate and make decision during the execution of the business process.

When the tasks for all of the work steps 202 have been performed, the system 10 then notifies the user that the business process has been completed (Step 412). Particularly, the business process execution and monitoring module 60 consolidates data and results associated with the execution of the business process, and generates a report for the user.

Business Process Analysis and Optimization

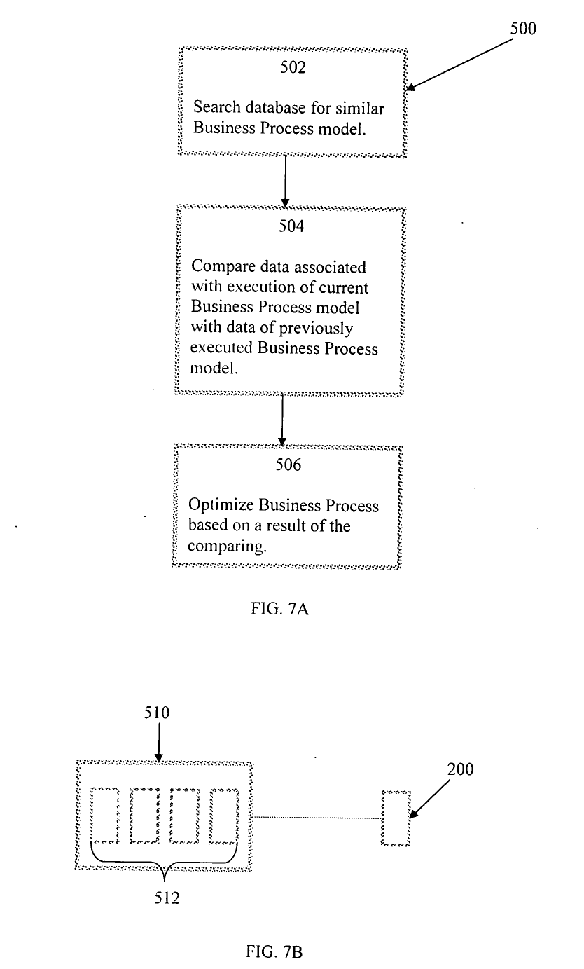

Returning to FIG. 2, after the business process model 200 has been executed, the business process analysis and optimization module 70 then analyze results of the execution (Step 180). FIG. 7A shows a method 500 for analyzing results of a business process execution. First, the business process analysis and optimization module 70 searches previously created business process models 512, such as business process models constructed by other users, to find a previously created business process model that best matches the current business process model 200 (Step 502). The previously created business process models 512 can be stored in a data base 510, such as a server, a hard drive, a CD ROM, or other computer medium known in the art (FIG. 7B). In the illustrated embodiments, the previously created business process models 512 include models that have been previously executed. Alternatively, or additionally, the previously created business process models 512 can include un-executed business process models.

Various methods can be used to search for a best matched business process model. In some embodiments, each business process model 512, 200 has an associated identification that represents certain characteristic(s) of the business process model. For example, the current business process model 200 can have an identification, “Mkt2Ph3Pr34V6”, indicating that the business process model 200 is labeled “V6” and is for phase 3 of a marketing project (having identification “2”) of a product (having identification “34”). In such cases, the business process analysis and optimization module 70 will search the data base 510 and look up all previously created business process models 512 having “Mkt2Ph3Pr34” as part of their identifications. For example, the business process analysis and optimization module 70 may determine that the business process models 512 having identifications “Mkt2Ph3Pr34V3” and “Mkt2Ph3Pr34V5” satisfy the search criteria. The business process analysis and optimization module 70 then provide search results to the user and allows the user to select which of the found results is to be used for comparison with the current business process model 200. Alternatively, the business process analysis and optimization module 70 automatically determines the best matched business process model 512 for the user based on a prescribed search criteria. For example, if two matched business process model 512 are found, the business process analysis and optimization module 70 can select the more recent model 512, or the model 512 created by a certain user, as the best match.

In alternative embodiments, the business process analysis and optimization module 70 performs a higher level search by comparing work steps of previously created business process models 512 with the work steps 202 of the current business process model 200. In such cases, the business process analysis and optimization module 70 provides the previously created business process model 512 having the most similar work step as that of the current business process model 200 as the search result. In some embodiments, the business process analysis and optimization module 70 also compares tasks associated with the work step of the business process model 512 with those associated with the current business process model 200 in order to determine the best match. Also, details of execution, types of data recorded, and model rules of the previously created business process models 512 and the current business process model 200 can also be compared to determine the best match.

In other embodiments, the search for the best matched previously created business process model 512 is not performed by the business process analysis and optimization module 70. In such cases, the search is performed manually by the user or an analyst. For example, the user can search the data base 510 using another software or application, such as Window Explorer. The user can type in certain prescribed search term(s) to look for a desired business process model 512 in the data base 510.

Once the best matched business process model has been found, the business process analysis and optimization module 70 then compares execution results (if they are available) of the previously created business process model 512 and the current business process model 200 (Step 504).

After the execution results of the previously created business process model 512 and the current business process model 200 have been compared, the business process analysis and optimization module 70 then provides a summary or report of the comparison result to the user (Step 506). The business process analysis and optimization module 70 also allows the user of the current business process model 200 to adopt one or more work steps of the previously created business process model 512. For example, if the comparison result indicates that a particular work step, or task within a work step, of a previously created business process model 512 is more efficient or cost effective that that associated with the current business process model 200, the user can then replace the work step, or the task within a work step, of the current business process model 200 with another from the previously created business process model 512. In some embodiments, the business process analysis and optimization module 70 also allows other users (i.e., author) of the previously created business process models 512 to adopt one or more work steps of the current business process model 200. This feature of the system 10 allows business processes associated with the previously created business process models 512 and the current business process model 200 to be optimized. In some embodiments, instead of allowing the user of the current business process model 200 to adopt a work step or task from another business process model 512, the business process analysis and optimization module 70 automatically revises the current business process model 200 based on the comparison by adopting a work step or a task from another business process model 512. In such cases, the business process analysis and optimization module 70 notifies the user of the changes, and the user will have the option of accepting or rejecting the changes.

In some embodiments, the business process analysis and optimization module 70 also allows publishing of a business process model as a company standard. For example, the business process analysis and optimization module 70 can be configured to allow authors of the business process models 512, 200 to decide on a most desirable business process model for use as a company standard, and post such business process model in the company's website. The most desirable business process model can be one in which, each of the work steps yields the best performance, the overall corresponding business process provides the best result, or certain prescribed criteria are met. The most desirable business process model can be selected by one or more users, or alternatively, be automatically determined by the business process analysis and optimization module 70. Alternatively, instead of posting the most desirable business process model in a website, the business process analysis and optimization module 70 can be configured to notify entities the most desirable business process model. The notification can be performed, for example, via emails, or other communication means known in the art. In some embodiments, the most desirable business process model can be transmitted to another entity, such as a company, an organization, a city, or a country.

The optimized business process model together with the previously created business process models can be stored in the data base 150, thereby allowing future users to use as references. For example, if another user wants to initiate a business process for performing a marketing project having identification “2” for product having identification “34”, the user can look up “Mkt2Ph*Pr34*” to see if a similar or same business process has been executed previously. If so, the system 10 allows the user to create a new business process model by making a copy of a previously created model and modifying the copied model if necessary. In some embodiments, the system 10 also keeps track of all of the created business process models, and records all copying and modification of the business process models. This feature allows users to see what steps have taken place to optimize a business process.

Although the above embodiments of the system 10 have been described as having the business process creation module 20, the business simulation module 50, the business process execution and monitoring module 60, and the business process analysis and optimization module 70 for performing certain functions, in alternative embodiments, one or more of the modules 20, 50, 60, 70 can be combined with another one of the modules 20, 50, 60, 70. For example, in some embodiments, the business process execution and monitoring module 60 can be combined with the business process analysis and optimization module 70. Also, in alternative embodiments, the system 10 need not include all of the modules 20, 50, 60, 70 for performing all of the functions described herein. For example, in some embodiments, the functions performed by the business process analysis and optimization module 70 can be performed by another system that is separate from the system 10. Furthermore, any of the modules 20, 50, 60, 70 described herein can be implemented using software, hardware, or combination of both.

Thus, a system capable of benchmarking, monitoring, reporting, analyzing, and optimizing business process performance has been provided. The system tracks and archives all interaction between entities involved during a business process, and brokers communication between entities involved in the business process. The system also tracks and measures performance and progress during all stages of a business process, and provides notification to entities at various levels for allowing optimal control over the business process. In accordance with some aspects of the invention, the system allows users to record and store business process models and data associated with execution of the business process models such that future users can reuse previously created business process without reinventing the process. Furthermore, the system also allows optimization of a business process by documenting results of each work step of the business process and comparing work steps and/or results of previously executed business processes. Such feature has the advantages of preventing lost of value-adding techniques, innovations, and discoveries accomplished during the previously executed business processes, and reducing the risks that the same mistakes occurred in previously executed business processes be repeated in a current business process.

Computer System Architecture

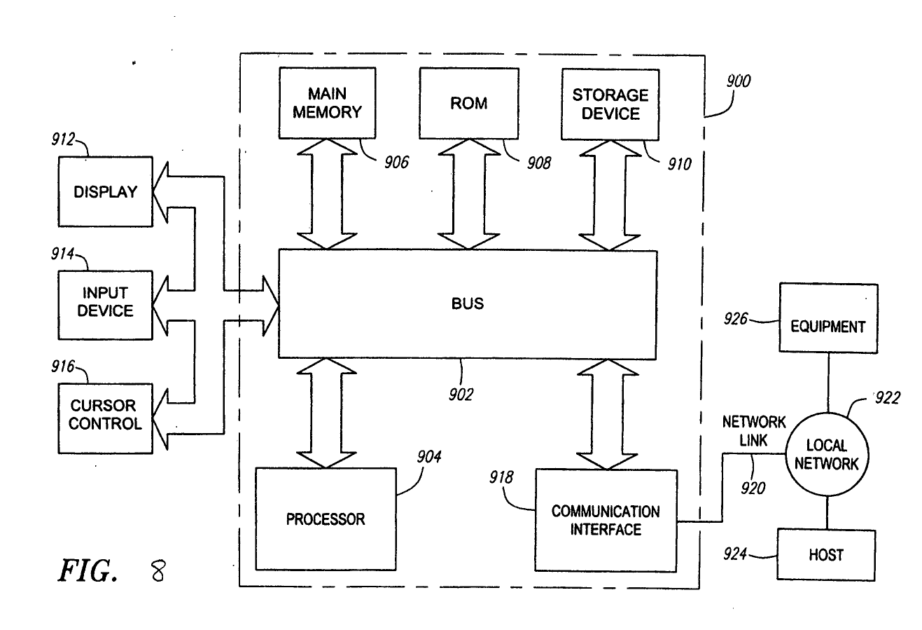

FIG. 8 is a block diagram that illustrates an embodiment of a computer system 900 upon which an embodiment of the invention may be implemented. Computer system 900 includes a bus 902 or other communication mechanism for communicating information, and a processor 904 coupled with the bus 902 for processing information. The computer system 900 also includes a main memory 906, such as a random access memory (RAM) or other dynamic storage device, coupled to the bus 902 for storing information and instructions to be executed by the processor 904. The main memory 906 also may be used for storing temporary variables or other intermediate information during execution of instructions to be executed by the processor 904. The computer system 900 further includes a read only memory (ROM) 908 or other static storage device coupled to the bus 902 for storing static information and instructions for the processor 904. A data storage device 910, such as a magnetic disk or optical disk, is provided and coupled to the bus 902 for storing information and instructions.

The computer system 900 may be coupled via the bus 902 to a display 912, such as a cathode ray tube (CRT), for displaying information to a user. An input device 914, including alphanumeric and other keys, is coupled to the bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for automating and optimizing a business process. According to one embodiment of the invention, such use is provided by computer system 900 in response to processor 904 executing one or more sequences of one or more instructions contained in the main memory 906. Such instructions may be read into the main memory 906 from another computer-readable medium, such as storage device 910. Execution of the sequences of instructions contained in the main memory 906 causes the processor 904 to perform the process steps described herein. One or more processors in a multi-processing arrangement may also be employed to execute the sequences of instructions contained in the main memory 906. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 904 for execution. Such a medium may take many forms, including but not limited to, non-volatile media, volatile media, and transmission media. Non-volatile media includes, for example, optical or magnetic disks, such as the storage device 910. Volatile media includes dynamic memory, such as the main memory 906. Transmission media includes coaxial cables, copper wire and fiber optics, including the wires that comprise the bus 902. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 904 for execution. For example, the instructions may initially be carried on a magnetic disk of a remote computer. The remote computer can load the instructions into its dynamic memory and send the instructions over a telephone line using a modem. A modem local to the computer system 900 can receive the data on the telephone line and use an infrared transmitter to convert the data to an infrared signal. An infrared detector coupled to the bus 902 can receive the data carried in the infrared signal and place the data on the bus 902. The bus 902 carries the data to the main memory 906, from which the processor 904 retrieves and executes the instructions. The instructions received by the main memory 906 may optionally be stored on the storage device 910 either before or after execution by the processor 904.

The computer system 900 also includes a communication interface 918 coupled to the bus 902. The communication interface 918 provides a two-way data communication coupling to a network link 920 that is connected to a local network 922. For example, the communication interface 918 may be an integrated services digital network (ISDN) card or a modem to provide a data communication connection to a corresponding type of telephone line. As another example, the communication interface 918 may be a local area network (LAN) card to provide a data communication connection to a compatible LAN. Wireless links may also be implemented. In any such implementation, the communication interface 918 sends and receives electrical, electromagnetic or optical signals that carry data streams representing various types of information.

The network link 920 typically provides data communication through one or more networks to other devices. For example, the network link 920 may provide a connection through local network 922 to a host computer 924 or to an equipment 926. The data streams transported over the network link 920 can comprise electrical, electromagnetic or optical signals. The signals through the various networks and the signals on the network link 920 and through the communication interface 918, which carry data to and from the computer system 900, are exemplary forms of carrier waves transporting the information. The computer system 900 can send messages and receive data, including program code, through the network(s), the network link 920, and the communication interface 918.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. For example, any or a combination of the operations performed by any of the modules of the system 10 can be performed by hardware, software, or combination thereof within the scope of the invention, and should not be limited to particular embodiments described herein. The specification and drawings are, accordingly, to be regarded in an illustrative rather than restrictive sense. The present inventions are intended to cover alternatives, modifications, and equivalents, which may be included within the spirit and scope of the present inventions as defined by the claims.

1. A method for executing a business process, comprising:
obtaining an entity model representative of an entity to which a task associated with said business process can be assigned;
obtaining a work model representative of a task to be assigned to said entity; and
assigning said task to said entity based on said entity model and said work model to thereby carry out said business process.

2. The method of claim 1, wherein said entity is selected from the group consisting of a person, a group of persons, a machine, a device, a software, a company, an association, and a country.

3. The method of claim 1, wherein said entity model is obtained by selecting an entity template from a plurality of available entity templates, each of said plurality of available entity templates associated with an entity to which a task can be assigned.

4. The method of claim 1, wherein said entity model is obtained by creating said entity model.

5. The method of claim 4, wherein said creating includes generating a record, assigning an entity identification to the record, and inputting an attribute to the record, said attribute representative of a characteristic of said entity.

6. The method of claim 1, wherein said entity model is obtained by retrieving said entity model from a data base.

7. The method of claim 1, wherein said work model is obtained by selecting a task template from a plurality of available task templates, each of said plurality of task templates associated with a task that can be assigned to an entity.

8. The method of claim 7, wherein each of the available task templates includes an instruction for performing a task.

9. The method of claim 1, wherein said work model is obtained by creating said work model.

10. The method of claim 9, wherein said creating comprises inputting one or more tasks to be performed by an entity.

11. The method of claim 9, wherein said creating comprises inputting an instruction for performing a task.

12. The method of claim 1, wherein said work model is obtained by retrieving said work model from a data base.

13. The method of claim 1, further comprising creating a business process model using said entity model and said work model.

14. The method of claim 13, wherein said creating said business process model comprises constructing a flow chart, said flow chart having at least one work step.

15. The method of claim 14, wherein said at least one work step represents said task that is to be assigned to said entity.

16. The method of claim 1, wherein said assigning is performed by a software or a human.

17. The method of claim 1, further comprising collecting data associated with work performed by said entity.

18. The method of claim 17, further comprising comparing said data with data associated with a previously created business process.

19. The method of claim 18, further comprising optimizing said business process based on said comparing.

20. The method of claim 19, further comprising creating a business process model using said entity model and said work model, wherein said creating said business process model comprises constructing a flow chart, said flow chart having a work step, and said optimizing comprising substituting said work step with a previously created work step.

21. The method of claim 19, wherein said optimizing comprises substituting said work model with a previously created work model.

22. The method of claim 19, further comprising adopting said optimized business process as a standard.

23. A method for optimizing a business process, comprising:
collecting a first set of data associated with an execution of a first business process model representative of a first business process;
searching a data base for a second business process model representative of a second business process; and
comparing said first set of data with a second set of data associated with said second business process.

24. The process of claim 23, wherein said first business process model includes a first plurality of work steps, and said searching comprises finding a business process model that has same or similar work steps as those associated with said first business process model.

25. The process of claim 23, wherein said first business process model has a first model identification, and said searching comprises finding a business process model that has a same or a similar model identification as that of said first business process model.

26. The process of claim 23, wherein said process further comprises optimizing either or both of said first and the second business processes based at least in part on said comparing.

27. The process of claim 26, wherein said first business process is optimized, and said second business process is not optimized.

28. The process of claim 26, wherein said second business process is optimized, and said first business process is not optimized.

29. A method for optimizing a business process involving a performance of a task, said method comprising:
obtaining data associated with performance of said task;
comparing said data with data associated with previously created business process; and
automatically determining an optimized business process based at least on said comparing.

30. The method of claim 29, wherein said data is selected from the group consisting of cost of performing said task, time required to perform said task, and number of persons involved in performing said task.

31. The method of claim 29, wherein said automatically determining is performed using a software or a device.

32. A computer product having a set of stored instructions, the execution of which causes a process to be performed, the process comprising providing an entity template representative of an entity to which a task associated with a business process can be assigned.

33. The computer product of claim 32, wherein said process further comprises providing a work template representative of a task which can be assigned to said entity.

34. The computer product of claim 33, wherein said process further comprises assigning said task to said entity.

35. The computer product of claim 32, wherein said entity is selected from the group consisting of a person, a group of persons, a machine, a device, a software, a company, an association, and a country.

36. A computer product having a set of stored instructions, the execution of which causes a process to be performed, said process comprising providing a user interface for allowing a user to create an entity model representative of an entity to which a task associated with a business process can be assigned.

37. The computer product of claim 36, wherein said process further comprises providing a user interface for allowing a user to create a work model representative of a task that can be assigned to said entity.

38. The computer product of claim 37, wherein said process further comprises assigning said task to said entity.

39. The computer product of claim 36, wherein said entity is selected from the group consisting of a person, a group of persons, a machine, a processor, a software, a company, an association, and a country.

40. A computer product having a set of stored instructions, the execution of which causes a process to be performed, said process comprising:
collecting a first set of data associated with an execution of a first business process model representative of a first business process;
searching a data base for a second business process model representative of a second business process; and
comparing said first set of data with a second set of data associated with said second business process.

41. The computer product of claim 40, wherein said first business process model includes a first plurality of work steps, and said searching comprises finding a business process model that has same or similar work steps as those associated with said first business process model.

42. The computer product of claim 40, wherein said first business process model has a first model identification, and said searching comprises finding a business process model that has a same or a similar model identification as that of said first business process model.

43. The computer product of claim 40, wherein said process further comprises optimizing either or both of said first and the second business processes based at least in part on said comparing.

44. The computer product of claim 43, wherein said first business process is optimized, and said second business process is not optimized.

45. The computer product of claim 43, wherein said second business process is optimized, and said first business process is not optimized.

46. A system for business process automation and optimization, comprising:
a business process creation module for allowing a user to create a business model, said business process model having one or more work steps; and
a business process execution and monitoring module configured to assign one or more tasks to one or more entities based on said business process model.

47. The system of claim 46, further comprising a business process analysis and optimization module for optimizing a business process based on data collected from execution of said one or more tasks.

48. The system of claim 46, further comprising a business process simulation module for checking said business process model for errors.

49. The system of claim 46, wherein said one or more entities are selected from the group consisting of a person, a group of persons, a machine, a device, a software, a company, an association, and a country.
